(19) United States
(12) Patent Application Publication
(10) Pub. No.: US 2023/0138259 A1
(43) Pub. Date: May 4, 2023

(54) SYSTEM FOR ENERGY CONVERSION

(71) Applicant: FACTORYTALY S.R.L., Milano (IT)

(72) Inventors: Claudio FRANCAVILLA, Carugo (Como) (IT); Alessandro FRANCAVILLA, Carugo (Como) (IT); Matteo FRANCAVILLA, Carugo (Como) (IT)

(21) Appl. No.: 17/915,296

(22) PCT Filed: May 11, 2021
(86) PCT No.: PCT/IB2021/053981

§ 371 Date: Sep. 28, 2022

(30) Foreign Application Priority Data
May 13, 2020 (IT) 102020000010927

(51) Int. Cl. F03G 3/00

(52) U.S. Cl. CPC F03G 3/094

(57) ABSTRACT

A system for energy conversion includes a support structure which has a descent channel and an ascent channel connected at respective lower ends and a sealing device applied at the upper end of the descent channel. The system further includes at least one extensible element, switchable between a compressed configuration and a dilated configuration and sliding inside the support structure along a path extending from the descent channel to the ascent channel. The system further includes a plurality of locking means configured to individually and reversibly constrain respective portions of the extensible element to the support structure.

The present invention relates to the technical field of energy production.

In particular, the present invention relates to a system and a corresponding method for energy conversion.

In the state of the art, the most common systems for energy conversion are those which, for example, concern fluid (dynamic) machines of the operating or driving type.

In the case of a fluid machine of the operating type, it is possible to obtain the energy conversion from the machine to a fluid, and therefore a conversion/transfer of, for example, mechanical energy, into an energy of potential and/or kinetic type.

In the case of a fluid machine of the driving type it is possible to obtain the energy conversion from a fluid to the machine itself, hence a conversion/transfer of kinetic and/or potential energy into mechanical energy.

A more practical example of the best known fluid machines consists of grinding mills which exploit the energy of water or wind to operate the grinder or more complex machineries which use a pressurised fluid, such as water vapour.

In the state of the art, the known fluid machines are subject to some limitations due to the structural configuration of the machine itself and above all to the physical phenomena involved in the interaction process between machine and fluid and vice versa.

In other words, it is possible to classify and evaluate each fluid machine considering an efficiency value of the machine itself: it is known that fluid machines have an efficiency value which is not high considering the fact that the energy transformation involves dissipations thereof in the form of frictions and/or related thermal effects.

In this context, the technical task underlying the present invention is to propose a system for energy conversion and the respective conversion method which overcome the drawbacks and limitations of the known art mentioned above.

In particular, it is an object of the present invention to provide a system for energy conversion and a respective conversion method which allow to exploit/convert the energy of a gravitational, kinetic or other type, e.g., energy arising from the difference in density between two bodies/fluids, in a form of useful energy which can be, by way of example, energy of the kinetic or potential or electrical type or a combination thereof.

A further object of the present invention is to provide a system for energy conversion and a respective conversion method which have a high efficiency value in terms of energy conversion, i.e., a higher efficiency value with respect to the known type of machines and systems.

A further and different object of the present invention is to provide a system for energy conversion and a respective conversion method which are reversible and allow the at least partial recovery of energy which is fed into the system in the form of another type of energy while maintaining a high efficiency value with respect to the known type of reversible systems/machines.

The technical task mentioned and the objects stated are substantially achieved by a system for energy conversion comprising a support structure having a descent channel and an ascent channel connected at respective lower ends and a sealing device applied to the upper end of the descent channel.

The system further comprises a plurality of extensible elements, switchable between a compressed configuration and a dilated configuration, which can be arranged in a pile of extensible elements interconnected to each other.

The extensible elements are slidable inside the support structure along a path extending from the descent channel to the ascent channel.

The system further comprises a plurality of locking means configured to individually and reversibly constrain the respective portions of the extensible elements to the support structure.

It is also an object of the present invention a method for energy conversion which can be performed by a system according to the present invention.

In particular, according to such a method, the extensible elements are inserted in the descent channel.

Subsequently, the upper end of the descent channel is hermetically closed and a fluid is poured into the ascent channel.

The air present in the descent channel thus remains trapped therein and balances the pressure exerted by the fluid present in the ascent channel.

It is therefore possible to transfer, using the weight force of the pile itself, an air mass from an upper extensible element to a lower extensible element immersed in the fluid.

Therefore, by moving this lower extensible element into the ascent channel, it is possible to convert the energy due to the Archimedean thrust to which it is subjected into another form of energy.

Advantageously, the system and method described herein allow to exploit in a particularly efficient manner the specific structural features of the support structure and the extensible elements to transform a potential energy which the latter accumulate during the movement thereof from the descent channel to the ascent channel into another form of energy (electrical, potential, kinetic . . . ).

The dependent claims, included here for reference, correspond to possible embodiments of the invention.

Further features and advantages of the present invention will become more apparent from the description of an exemplary, but not exclusive, and therefore non-limiting, preferred embodiment of a system for energy conversion and a respective method, as illustrated in the appended drawings, in which:

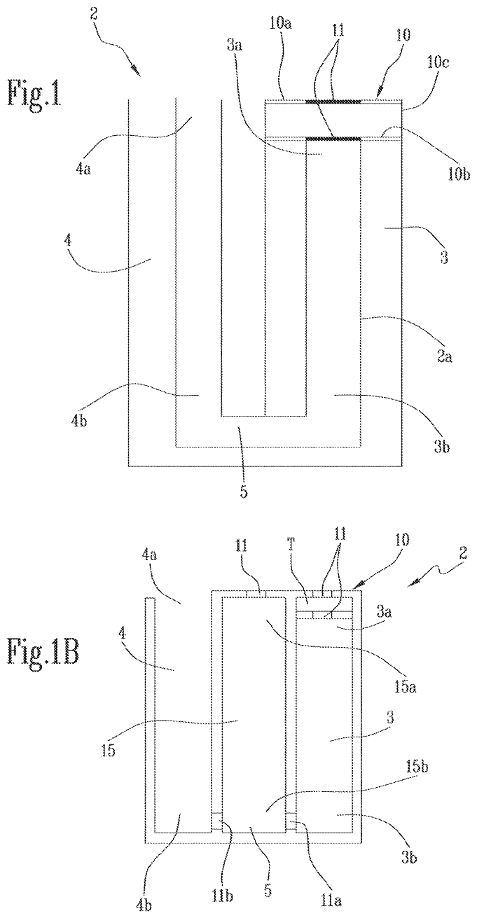

FIGS. 1A-1B illustrate schematic side views of a support structure of a system for energy conversion in accordance with respective embodiments;

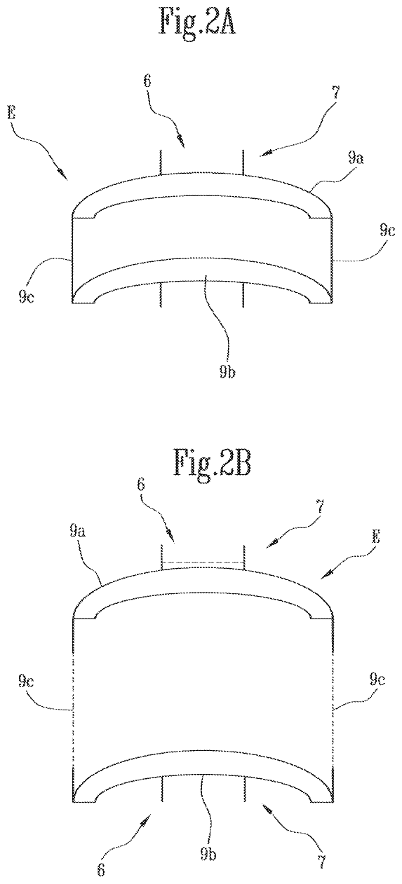

FIGS. 2A-2B show an extensible element in two different configurations;

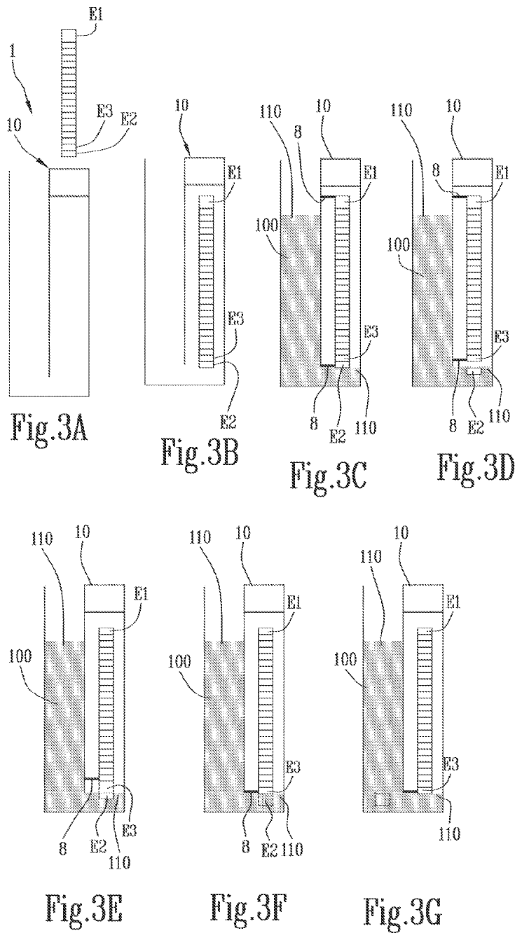

FIGS. 3A-3G schematically illustrate some operating steps of the energy conversion system;

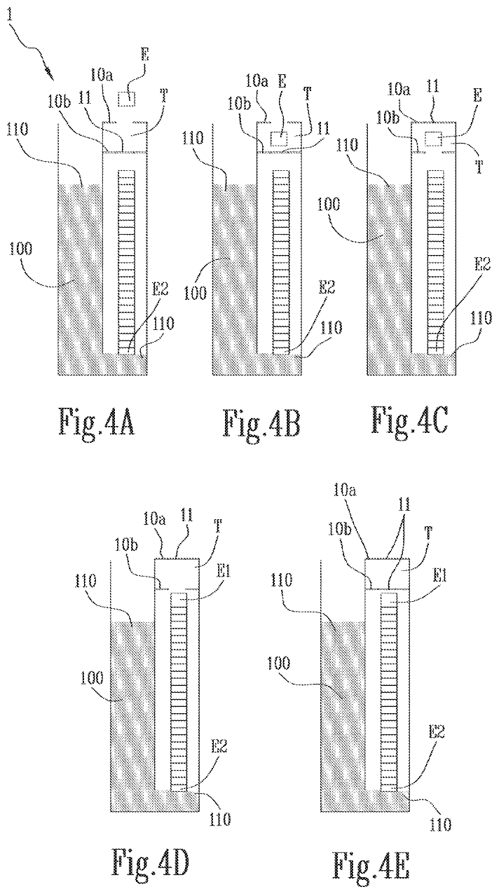

FIGS. 4A-4E schematically show some further operating steps of the energy conversion system.

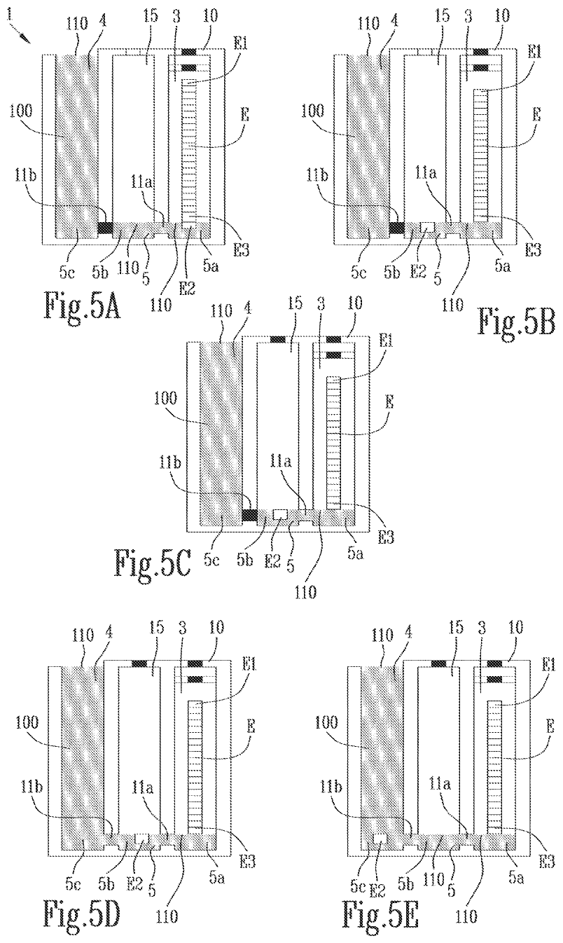

FIGS. 5A-5E schematically show some operating steps of a particular embodiment of the energy conversion system.

In the accompanying figures the reference numeral 1 generally indicates a system for energy conversion, which is referred to in the following description simply as system 1.

In particular, the energy conversion system 1 comprises a support structure 2 which has a shape such that at least one portion thereof is substantially “U” shaped.

In particular, the support structure has a descent channel 3 and an ascent channel 4 defining the arms of the “U” structure and a connection channel 5 which connects such arms.

More specifically, the descent channel 3 extends vertically between an upper descent end 3a and a lower descent end 3b, i.e., it has a main vertical extension axis in a normal use condition.

Similarly, the ascent channel 4 extends parallel to the descent channel 3 between an upper ascent end 4a and a lower ascent end 4b.

The connection channel 5 then connects the two channels 3, 4, in particular extending between the lower descent end 3b and the lower ascent end 4b, connecting them together.

Advantageously, the ascent channel 4 can have an inclined main extension direction with respect to a main extension direction of the descent channel.

Thereby, with the same height of the two channels 3, 4, the ascent channel 4 has a longer length, allowing to increase the capacity thereof for energy conversion because, as will be discussed below, the greater the inclination the longer the path which the extensible elements “E” will have to travel to ascend it.

In accordance with a possible alternative embodiment, the support structure has a shape such as to define an “L”-shaped structure with at least one portion thereof.

In this context, the descent channel 3 and the connection channel 5 have the same height, while the ascent channel 4 has a greater height.

Still in this context, the system 1 is preferably configured to operate the energy conversion by exploiting the movement inside and along the support structure 2 of a single extensible element “E”, while on the contrary in the previously identified case in which the support structure 2 defines a “U” structure through at least one portion thereof it is preferable to use a plurality of extensible elements “E” arranged in a pile.

In general, the conversion system 1 therefore comprises at least one waterproof extensible element “E” which can be submerged inside a fluid 100 during the normal operation of the system 1.

In accordance with a preferred embodiment to which explicit reference will be made in the following description by way of non-limiting example, the system 1 comprises a plurality of extensible elements “E”.

Each channel 3, 4, 5 is operatively configured to allow the sliding of a plurality of extensible elements “E”, preferably organised geometrically as a pile, i.e., stacked one over the other, and mechanically water-tightly interconnected to each other.

In accordance with operating requirements of the conversion system 1, the pile of extensible elements “E” can easily be inserted in the system 1 at the descent channel 3.

In particular, the system 1 comprises a sealing device 10 applied to the upper descent end 3a and configured to hermetically close it and through which the extensible elements “E” are introduced in the descent channel 3.

In more detail, the sealing device 10 defines a transfer chamber “T” enclosed by an upper panel 10a, a lower panel 10b and a plurality of peripheral panels 10c.

The upper panel 10a faces an external environment and has an insertion seat adapted to allow the passage of the extensible elements “E” inside the transfer chamber “T”.

The lower panel 10b instead faces the descent channel 3 and has an insertion seat adapted to allow the passage of the extensible elements “E” inside the descent channel 3.

The plurality of peripheral panels 10c p instead fluid-tightly connect the upper panel 10a to the lower panel 10b.

The sealing device 10 further comprises two hatches 11 coupled to respective insertion seats and configured to hermetically seal them.

As will be discussed in the following, the sealing device 10 then defines a water-tight transfer chamber “T” such that it is possible to insert the extensible elements “E” (one at a time or more than one at the same time) inside the transfer chamber “T” keeping the descent channel 3 isolated from the external environment, thus keeping the hatch associated with the lower panel 10b closed, and then transfer them to the descent channel 3 itself after isolating the transfer chamber “T” from the external environment by closing the hatch coupled to the upper panel 10a.

Structurally, the extensible elements “E” are configured to switch the state thereof between a compressed configuration and a dilated configuration and vice versa, for example by varying the internal volume which can be reached by means of a dilation/contraction procedure, better described below.

It is intended to draw attention to the fact that the structure of the extensible elements “E” is such as to remain relatively rigid and non-deformable even when subjected to the pressure exerted by the fluid in which the element 4 itself is immersed.

Preferably, the extensible elements “E” in the dilated configuration have a bulk volume of about 1.1 up to 2.5 times greater than the volume in the compressed configuration.

Even more preferably, the extensible elements “E” in the dilated configuration have a bulk volume equal to at least twice the bulk volume they have in the compressed configuration.

Furthermore, the extensible elements “E” are slidable inside the support structure 2 along a work path extending from the upper descent end 3a to the upper ascent end 4a.

In other words, the extensible elements “E” are configured to move through the support structure by entering at the upper descent end 3a, proceeding along the descent channel 3 to the lower descent end 3b and then entering the ascent channel 4 through the lower ascent end 4a thereof (passing through the connection channel 5).

At this point, the extensible elements “E” can ascend the ascent channel 4 in order to be extracted from the support structure 2 through the upper ascent end 4b.

Alternatively, it should be noted that in general the extensible elements can also be moved in the opposite direction, i.e., they can be brought from the ascent channel 4 to the descent channel 3 by passing through the connection channel 5 instead of from the environment outside the system 1.

Therefore, in general, the restoration of the initial conditions of the extensible element “E” can be carried out by extracting it from the ascent channel 4 and reinserting it in the descent channel 3, or by making it travel backwards along the path taken to arrive there.

To facilitate the movement of the extensible elements “E”, the support structure preferably comprises sliding guides 2a, illustrated by way of non-limiting example in FIG. 1A, arranged along each channel 3, 4, 5 and configured to allow and guide a low-friction sliding of the extensible elements “E” with respect to the support structure 2 itself.

According to a particular embodiment, shown in FIG. 1B, the support structure 2 further comprises a passage channel 15 extending between an upper passage end 15a and a lower passage end 15b.

The upper passage end 15a has a seat through which a fluid (e.g., air) can pass and comprises a hatch configured to hermetically and selectively close such a seat.

Potentially and for greater safety, the system could also comprise a further sealing device 10 coupled to the upper passage end 15a and operating in a similar manner corresponding to the passage device 10 coupled to the upper descent end 3a.

Furthermore, the passage channel 15 is interposed between the descent channel 3 and the ascent channel 4 to which it is connected through the connection channel 5 with which it interfaces at the lower passage end 15b thereof.

In accordance with such a specific embodiment, the connection channel 5 therefore has three distinct compartments associated with the descent channel 3, the passage channel 15 and the ascent channel 4 respectively at the respective lower ends 3b, 4b, 15b.

Still in this context, the connection channel 5 comprises hatches 11 interposed between each compartment and configured to hermetically water-tightly seal each compartment from the adjacent compartments.

in other words, the connection channel 5 has a first compartment 5a associated with the lower descent end 3b, a second compartment 5b associated with the lower passage end 15b and a third compartment 5c associated with the lower ascent end 4b.

The connection channel 5 further comprises a first hatch 11a interposed between the first compartment 5a and the second compartment 5b and a second hatch 11b interposed between the second compartment 5b and the third compartment 5c.

Therefore, the work path begins at the upper descent end 3a, extends through the descent channel 3 and continues through the first compartment 5a, the second compartment 5b and the third compartment 5b in order and then ends in the ascent channel 4.

The precise operation of the various hatches 11, 11a, 11b will be further explored below simultaneously with the description of the operation of the system 1.

With reference to the operation of the extensible elements “E”, they are configured to move an overall fluid 100 volume in which they are immersed equal to the total volume difference obtainable with the switching from the dilated configuration to the compressed configuration of each extensible element “E”.

With reference to the structure of each extensible element “E”, schematically illustrated in the attached FIGS. 2A and 2B, each extensible element “E” has an upper closing wall 9a and a lower closing wall 9b operatively coupled to each other by a deformable and/or extensible connecting peripheral wall 9c. Preferably, the upper wall 9a and the lower wall 9b are shaped with a hydrodynamic shape, i.e., aimed at reducing the dynamic frictions with the fluid 100.

Even more preferably, the upper wall 9a is shaped with a convex shape and the lower wall 9b is shaped with a concave shape.

The connecting peripheral wall 9c is made by an impermeable elastic-type sheath or by a composition of a plurality of rigid elements (not shown) which are collapsible on each other in a compressed extensible element “E” configuration and unwindable in a dilated extensible element “E” configuration.

The rigid elements not shown are configured to be impermeable and pressure-tight, as described so far for the structure of the extensible elements “E”, without any limitation in the technical solutions which can be adopted in accordance with the inventive concept of the present invention.

The deformation capacity of the connecting peripheral wall 9c allows the approaching/distancing of the upper wall 9a with the lower wall 9b of each extensible element “E” during the switching from the dilated configuration to the compressed configuration of the pile and vice versa.

As mentioned above, the extensible elements “E” have interconnection means 6 configured to be mechanically connected to one another.

Preferably, also the interconnection means 6 are configured to be mechanically water-tightly connected to one another, i.e., the interconnection means 6 are of the water-tight type.

The interconnection means 6 allow the mechanical connection between an extensible element “E” and the adjacent elements above and below it.

In particular, in accordance with the preferred embodiment of the present invention, the interconnection means 6 are arranged at each upper wall 9a and lower wall 9b of each extensible element “E”.

Each extensible element “E” further comprises a communication duct 7 configured to place an extensible element “E” of the pile in fluid communication with at least one further extensible element “E” adjacent thereto, or with at least one of the extensible elements “E” preceding and/or following it in the pile (i.e., which are arranged above or below it).

If there is only one extensible element “E”, such a communication duct 7 can be absent or reversibly hermetically closed.

Preferably, the communication ducts 7 of the individual extensible elements “E” are mutually connectable so as to create a single communication duct 7 extending uninterruptedly from an upper extensible element “E1” (i.e., an extensible element “E” above which there is no further extensible element “E”) of the pile to a lower extensible element “E2” (i.e., an extensible element “E” below which there is no further extensible element “E”) of the pile and is preferably such as to vary the length thereof in accordance with a height of the pile between the compressed configuration and the dilated configuration of the various extensible elements “E” composing it and vice versa.

The communication duct 7 allows the extensible elements “E” to dilate/contract both with the outside air and with the air already present inside the pile during the switching of the state thereof between the compressed configuration and the dilated configuration and vice versa.

I.e., the expansion of the various extensible elements “E” can occur by the introduction of an air mass from the external environment or by the passage of the same air mass from one extensible element “E” to the other.

In a possible embodiment, the communication duct 7 comprises sectors interposed between an extensible element “E” and the adjacent ones (for example above and below), such as a tube passing through the diaphragms subdividing the extensible elements “E” themselves.

In a different embodiment, the communication duct 7 can comprise an extensible telescopic tube passing through all the extensible elements “E” of the pile, starting from the lower extensible element “E2” up to the upper extensible element “E1”.

In a different and further embodiment, not shown, the communication duct 7 can be obtained along one or more of the sliding elements 2a of the system 1 by means of seal piping systems and fluid connecting techniques.

Furthermore, the system 1 comprises locking means 8 configured to constrain each extensible element “E” individually and reversibly to the support structure 2.

In other words, each individual extensible element “E” can be individually locked to the support structure 2 (preferably to the sliding guides 2a) so that also the movement of each extensible element “E” is independent with respect to that of any other extensible element “E” forming the pile.

For example, with the system according to the present invention, it would be possible to keep all the extensible elements “E” of a pile locked except one, which could therefore be individually moved without requiring the displacement of the entire pile.

In particular, the locking means 8 can be configured to engage the lower wall 9b and/or the upper wall 9a of each extensible element “E”.

The system 1 can further comprise a movement member, not illustrated in the accompanying figures, achievable for example by a hoist-operated movement system, a mechanical lever system or hydraulic and/or pneumatic systems.

The movement member is configured to move at least one extensible element “E” to bring it at the sealing device 10 and/or to promote the transfer of the extensible elements “E” inside the descent channel 3 through the sealing device 10 and/or to move the extensible elements “E” through the connection channel and/or through the transfer chamber “T”.

In use, as will be discussed below, the extensible elements are inserted into the descent channel and the upper end of the descent channel is hermetically closed.

A fluid is then poured into the ascent channel and the air present in the descent channel therefore remains trapped therein, balancing the pressure exerted by the fluid present in the ascent channel.

It is therefore possible to transfer, using the weight force of the pile itself, an air mass from an upper extensible element to a lower extensible element immersed in the fluid.

If a single extensible element “E” is present, the switching thereof in the dilated configuration can also be achieved by a different mechanism, for example by connecting the extensible element “E” to a pressurised air source (for example a compressor).

The above does not exclude that the pressurised air source can also be used for switching extensible elements “E” arranged in a pile or even only to aid such switching and that the switching change of the single extensible element “E” is not obtained by gravity, i.e. by exploiting the weight thereof.

Therefore, by moving this lower extensible element (or the only extensible element “E” if only one is present) into the ascent channel 4, it is therefore possible to convert the energy due to the Archimedean thrust to which it is subjected into another form of energy.

In accordance with the inventive concept of the present invention, the energy conversion system 1 is therefore configured to switch the energy accumulated by the extensible elements “E” from the dilated configuration in the form of an Archimedean thrust, to which the lower extensible element “E2” is subject, completely dilated and arranged at a distance below the free surface 110 of the fluid 100, into useful energy whose value is proportional to the depth at which such a lower extensible element “E2” is located and to the total fluid 100 volume displaced thereby due to the assumption of the configuration.

In other words, the greatest energy resource which the system is capable of exploiting and converting into another type of energy is given by the Archimedean thrust which is generated due to the different density between the fluid contained in the lower extensible element “E2” when dilated (preferably atmospheric air) and the fluid 100 density (preferably water) in addition to the distance from the free surface 110.

In particular, the energy conversion system 1 is configured to determine a conversion of potential energy into useful energy which can be exploited in the form of kinetic, electrical and/or potential energy which can be stored by means of a system of the mechanical, electrical type (for example dynamic, batteries, . . . ), or a system of hydraulic type or of another type.

In other words, the expression “useful energy” means any type of energy which can be stored/exploited and obtained by converting the potential energy deriving from the Archimedean thrust acting on an extensible element “E” in the dilated and immersed configuration at a certain distance from the free surface of a fluid.

Preferably, the useful energy obtained by means of conversion by the conversion system 1 of the present invention is kinetic energy which is exploitable by moving a body having a predetermined mass.

Preferably, the energy conversion system 1 of the present invention allows to exploit and/or accumulate the useful energy obtained from the conversion by transferring an amount of momentum to the body.

Alternatively, by way of non-limiting example, the energy conversion system 1 comprises conversion means comprising an impeller and an electric generator or other bodies having a variable mass according to the condition of use of the system, such as a catenary of ballast elements.

The energy conversion system 1 is configured to also manage the switching of the extensible elements in the compressed configuration starting from the (complete or partial) dilated configuration.

In accordance with the inventive concept of the present invention, the switching of the extensible elements “E” from the dilated configuration to the compressed configuration preferably occurs by the effect of a gravity force acting at least on an extensible element “E” in the (complete or partial) dilated configuration.

In other words, the energy conversion system 1 of the present invention is such as to restore the compressed configuration of the extensible elements by exploiting the gravity force acting on the structure of each extensible element “E”.

During the restoration of the compressed configuration of the extensible elements “E”, the amount of excess air contained in the same elements 4 escapes through the communication duct 7 described above.

The same communication duct 7 is configured to contract and reduce the length thereof.

In accordance with a further aspect of the present invention, the system 1 comprises a tank for the fluid 100 arranged below the ascent channel 4 and placed in fluid communication with the lower ascent end 4b.

The tank is configured to contain, in a use configuration, a sufficient amount of fluid 100 to completely fill the ascent channel 4 and the connection channel 5.

As will be discussed in more detail below, the transfer of the fluid 100 from the tank to the connection channel 5 and ascent channel 4 is carried out by immersing a body inside the tank itself, causing the fluid 100 to outflow from the latter.

In particular, the tank comprises a main portion in which the fluid 100 is stored and an upper storage portion inside which the body can be stored when the system 1 is inactive or in any case the presence of the fluid 100 inside the connection channel 5 and ascent channel 4 is unnecessary.

Preferably, the main portion defines an extension of the ascent channel 4.

Such an upper storage portion can be positioned parallel to the ascent channel 4 and connected thereto by a resealable opening through which the body can be passed.

The tank can further comprise a lower storage portion arranged below the upper storage portion and parallel to the main portion.

During the use of the system it is possible to position the body therein so as to ensure that the latter does not interfere with the movement of the extensible elements “E” and therefore does not affect the correct operation of the system.

Advantageously, the body can be or comprise one or more extensible elements “E” and/or one or more rigid elements equivalent both structurally and functionally to an extensible element “E” placed in the dilated configuration or in the compressed configuration, except that it is unable to switch between one configuration and the other.

In accordance with a preferred embodiment, the body comprises at least one extensible element “E” and at least one rigid element, overlapping and reversibly constrained to each other to define a pile, in which preferably each extensible element “E” forming part of the body has the same weight, just as each rigid element has the same weight.

Furthermore, the weight of the extensible elements “E” can be less than the weight of the rigid elements.

In this context, the ascent channel 4 can further comprise one or more hatches arranged at different heights.

Such hatches can be opened/closed during the operation of the system 1 to influence the pressures exerted by the fluid 100 volumes on the individual components and in particular on the walls of the channels 3, 4, 5.

In particular, in the closed configuration the hatches separate the ascent channel 4 into a plurality of distinct sections and support part of the weight of the fluid 100 contained therein and therefore when the ascent channel 4 is placed in communication with the other channels 3, 5 the pressure exerted on the latter by the fluid is reduced proportionally to the fluid 100 volume sustained by the hatches.

Advantageously, the system for energy conversion allows to exploit a component (in terms of force) of the Archimedean thrust, determined by the variation in volume which each extensible element performs, so as to convert/store it in the form of kinetic and/or potential energy or an increase in the momentum of a body having a predetermined mass.

It is also the object of the present invention a method for energy conversion, preferably performable by an energy conversion system 1 having one or more of the technical features described above, as shown for example in FIG. 3A.

In particular, as can be seen in FIG. 3B, the method is performed by preparing the system 1 to operate by arranging a pile of extensible elements “E” inside the descent channel 3 at the upper end 3a thereof.

In particular, the pile is prepared so that the upper extensible element “E1” results in the dilated configuration (which therefore contains an air mass), while each other extensible element “E” component of the pile is in the compressed configuration.

At the same time, the movement of each extensible element “E” is also completely blocked so as to constrain them to the support structure 2 and prevent unwanted movement.

In particular, as can be seen in FIG. 3C, such a result can be obtained by activating the locking means 8 on the upper wall 9a of the upper extensible element “E1” and on the lower wall 9b of the lower extensible element “E2”.

The upper descent end 3a is then hermetically closed by the sealing device 10, thereby sealing the descent channel 3.

The ascent channel 4 is then filled with a fluid 100 (preferably water) so as to fill it at least partially, thus completely flooding the connection channel.

As can be seen still in FIG. 3C, due to the presence of the sealing device 10, the air present inside the descent channel 3 remains trapped therein and once the connection channel 5 is completely flooded it can no longer escape therefrom, so that the fluid which is introduced into the ascent channel 4 cannot enter the descent channel 3, but will simply generate a thrust which will compress the air present therein until it is balanced by the consequent increase in pressure.

In other words, once the fluid 100 has been introduced into the ascent channel 4, the situation occurs in which the connection channel 5 is completely filled with the fluid 100, the ascent channel is at least partially filled with the fluid 100, while the descent channel 2 (inside which the pile of extensible elements “E” is located) is full of air.

The air present inside the descent channel 2 is in pressure equilibrium with the fluid present inside the ascent channel 4 and the connection channel 5 with an interface between the two (corresponding to a free surface 110 of the fluid 100) which is arranged at the lower descent end 3b.

In particular, under the pressure of the weight force of the fluid 100 present in the ascent channel 4, the free surface 110 of the fluid 100 reaches a level such that the lower extensible element “E2” is facing it, preferably having the lower wall thereof in direct contact with said free surface 110.

It should be noted that the steps identified so far in fact represent an installation/arrangement procedure of the system 1 and therefore the performance thereof is not necessary in each of the individual operating cycles of the system 1 itself which are described below.

Such steps can therefore be carried out either during the first installation of the system 1 or following any maintenance operations in which it was necessary to remove the fluid 100 from the system 1 or extract the entire pile of extensible elements “E” at the same time (for example to replace/maintain one or more thereof).

As shown in FIG. 3D, the operation of the method therefore includes unlocking the lower extensible element “E2” so as to detach it from the immediately overlying extensible element “E3”, identified and referred to below simply as the penultimate extensible element “E3”.

Thereby, the lower extensible element “E2” is detached from the pile and is free to move along the descent channel and is dropped into the fluid 100, preferably until it is completely immersed in the latter, even more preferably immersing it so that the upper wall of the lower extensible element “E2” lies flush with the free surface 110 of the fluid 100 (simultaneously, to prevent the movement of the entire pile, the movement of the lower wall 9b of the penultimate extensible element “E3” is locked).

As shown in FIG. 3E, only the lower wall 9b of the penultimate extensible element “E3” is unlocked, simultaneously locking the upper wall 9a, and the air mass contained in the upper extensible element “E1” is transferred to the penultimate extensible element “E3”, restoring the compressed configuration of the upper extensible element “E1” and consequently causing the dilation of the penultimate extensible element “E3”.

The movement of the air mass can be performed passively, i.e., only under the effect of the weight of the upper extensible element “E1” which promotes the compression thereof which is compensated by the simultaneous expansion of the penultimate extensible element “E3”.

Alternatively, the movement of the air mass can be performed actively, i.e., appropriate actuators (integrated or not in the system 1) can be used which act by pushing on the upper wall of the upper extensible element “E1” pushing out the air mass or by pulling the lower wall 9b of the penultimate extensible element “E3”, sucking the air mass therein.

Operatively, again as can be seen in FIG. 3E, the expansion of the penultimate extensible element “E3” expands it to the point where the lower wall thereof abuts against the upper wall of the lower extensible element “E2” (thus preferably positioned at the level of the free surface 110 of the fluid 100) allowing the two to reconnect to each other.

Through the steps just described, the air mass is then transferred into the penultimate extensible element “E3” and all the extensible elements “E” of the pile are connected to each other, in particular with only the lower extensible element “E2” immersed in the fluid 100.

As shown in FIG. 3F, next the movement of the upper wall 9a of the lower element “E2” is locked and then the movement of each other extensible element “E” is unlocked.

Thereby, the thrust of the weight force exerted by the pile of extensible elements “E” placed above the penultimate extensible element “E3” causes the compression thereof, pushing the air mass contained therein inside the lower extensible element “E2”.

In other words, the compressed configuration of the penultimate extensible element “E3” is restored and at the same time the dilation of the lower extensible element “E2” is caused.

It should be noted that the weight force exerted by the pile of extensible elements “E” is in particular greater than the pressure exerted by the fluid 100 against the lower extensible element “E2”.

As shown in FIG. 3G, the lower extensible element “E2” is then moved from the lower descent end 3a to the lower ascent end 3b, conveying it through the connection channel 5.

Thereby, the lower extensible element “E2” is located at the base of the ascent channel 4 where it is therefore surmounted by the column of fluid 100 present therein and thus being subject to an Archimedean thrust whose intensity is proportional to the air mass contained therein and to the depth thereof with respect to the free surface 110 of the fluid 100 in the ascent channel 4.

It is then possible to complete a first cycle of energy conversion by converting said Archimedean thrust acting inside the ascent channel 4 on the lower extensible element “E2” immersed in the fluid 100 into kinetic energy by moving a body having a predetermined mass, preferably accumulating said kinetic energy in the form of a momentum of said body; and/or into potential energy by moving a body having a predetermined mass; into electricity by driving an electric generator.

The performance of successive conversion cycles can simply be performed by preparing a further extensible element “E”, which can advantageously be the lower extensible element “E2” of a just completed cycle.

As shown in FIG. 4A, such a further extensible element “E” is brought into the dilated configuration and then inserted into the transfer chamber “T”.

As shown in FIG. 4B, while the extensible element “E” is placed inside the transfer chamber “T” the hatch coupled to the insertion seat of the lower panel 10b is closed so as to hermetically seal the upper descent end 3a and thus ensure the maintenance of the equilibrium condition between the fluid 100 present in the ascent channel 4 and the air trapped inside the descent channel 3.

As shown in FIG. 4C, the hatch coupled to the insertion seat of the upper panel 10a is then closed, hermetically sealing the transfer chamber “T”.

At this point it is possible to open the hatch coupled to the insertion seat of the lower panel 10c (the air present in the descent channel 3 cannot outflow since the insertion seat of the upper panel 10a is closed) and, as shown in FIG. 4D, transfer the extensible element “E” into the descent channel 3.

As shown in FIG. 4E, the extensible element “E” is connected to the pile of extensible elements “E” already present inside the descent channel 3, thus becoming the upper extensible element “E1” of such a pile.

At this point it is possible to repeat the steps already indicated above and illustrated schematically in FIGS. 3C-3G in order to complete a further conversion cycle.

FIGS. 5A-5E instead show in detail some steps related to the operation of a system 1 comprising a support structure 2 made in accordance with the specific embodiment shown in FIG. 1B, i.e., a support structure 2 having, in addition to the descent channel 3 and the ascent channel 4, also the passage channel 15 interposed between the two.

It should be noted that the preliminary steps of arranging the system 1, i.e., those illustrated in FIGS. 3A-3C, are carried out in a substantially similar manner also for the arrangement of a system 1 also comprising the passage channel 15.

In other words, the pile of extensible elements “E” is inserted inside the descent channel 3 keeping only the upper extensible element “E1” in dilated configuration and the upper descent and passage ends 3a and 15a are hermetically closed (the first by the sealing device 10 and the second by the respective hatch 11).

The fluid 100 is then poured into the ascent channel 5 until the connection channel 5 is completely flooded so that the free surface 100 of the fluid 110 is at the lower descent 3b and passage 15b ends and the air volume contained inside the upper extensible element “E1” is transferred to the penultimate extensible element “E3”.

In accordance with such an embodiment, once the air volume has been transferred to the penultimate extensible element “E3”, the first hatch 11a and the hatch associated with the upper passage end 15a are opened, while all the other hatches of the system 1 (the second hatch 11b and the hatches 11 of the sealing device 10) remain closed, as shown in FIG. 5A.

In this situation, the only pressure weighing on the last extensible element “E2” is that generated by the fluid 100 present in the first compartment 5a and in the second compartment 5b of the connection channel 5, since all the fluid 100 present in the ascent channel is isolated by virtue of the second hatch 11b.

It is therefore possible to transfer the air volume inside the lower extensible element “E2” according to the methods already discussed with greater simplicity and efficiency, and bring it inside the second compartment 5b as illustrated in FIG. 5B.

At this point it is possible to close the hatch 11 coupled to the upper passage end 15b to completely isolate the passage channel 15 and the descent channel 3 from the external environment as shown in FIG. 5C.

Thereby, during the subsequent opening of the second hatch 11b, shown in FIG. 5D, the equilibrium condition is maintained between the fluid 100 contained in the ascent channel 4 and in the connection channel 5 with the air present in the passage channel 15 and in the descent channel 5 which cannot outflow from the respective channels 3, 15.

It is therefore possible to convey the lower extensible element “E2” to the third compartment 5c as shown in FIG. 5E and then make it ascend along the ascent channel 4 transforming the Archimedean thrust to which it is subjected into kinetic/potential/electrical energy according to the methods already discussed.

The reinsertion of the extensible elements “E” inside the descent channel 3 can also be performed in this context according to the methods already described and illustrated schematically in FIGS. 4A-4E.

Advantageously, the method according to the present invention overcomes the drawbacks and inefficiencies highlighted and evidenced in the prior art by allowing the weight force of the pile of extensible elements “E” to be exploited to efficiently transfer an air mass at a certain depth inside the fluid 100 column present in the ascent channel.

Such an air mass generated is therefore subject to a potential energy due to the Archimedean thrust to which it is subject which can be converted into other forms of energy according to one or more of the specific procedures outlined above.

In general, the filling of the connection channel 5 and the ascent channel 4 occurs by pouring the fluid 100 therein.

Alternatively, in the specific case in which the system 1 comprises a tank having the features described above and in depth, the filling of the connection channel 5 and the ascent channel 4 is obtained by moving the fluid 100 contained inside the tank.

In greater detail, a body is immersed inside the tank causing the outflow of the fluid 100 present therein, which first floods the connection channel 5 and then fills the ascent channel 4.

In even more detail, the procedure outlined herein is performed by moving the body from an upper storage portion of the tank to the inside of the ascent channel 4.

Such a step can be performed by opening a passage opening present between the ascent channel 4 and the upper storage portion and closing it immediately after the transfer of the body inside the ascent channel 4.

From the ascent channel 4 the body is progressively immersed inside the main portion of the tank, causing the fluid 100 to outflow.

Optionally, if present, it is possible to move the body in the lower storage portion so as to ensure that it does not hinder the movement of the extensible elements “E” along the path extending between the descent channel 3 and the ascent channel 4.

Thereafter, it is possible to move the body by performing the steps just illustrated in reverse in order to be able to return the system 1 to the initial condition.

In greater detail, in the specific case in which the body is formed by a pile of at least one extensible element “E” and at least one rigid element, when the body is in the upper storage portion, the extensible element is placed in dilated configuration above the rigid element (or in general all the extensible elements “E” are placed above all the rigid elements).

Subsequently the body is immersed in the tank, causing the fluid to ascend inside the ascent channel.

It is therefore possible to proceed with the movement of the extensible element “E” responsible for determining the energy conversion, i.e., the extensible element which must ascend the ascent channel 4.

Once the procedure for moving the extensible element along the ascent channel (and possibly the return thereof inside the descent channel 3) has been completed, it is possible to work on the body's constituent elements to modify the configuration thereof, in particular the extensible elements “E” are separated from the rigid elements and positioned therebelow.

In other words, the extensible elements “E” and the rigid elements exchange places by detaching and moving so as to reverse the position thereof.

The body can then be returned to the upper storage portion to return the entire system 1 to the initial configuration.

To perform such a procedure, it is sufficient to make the body ascend until it is substantially next to the upper storage portion.

In detail, the ascent of the body can be achieved by appropriate movement means which preferably act by traction, lifting the body (for example by cables connected/connectable with the constituent elements of the body).

Possibly, the ascent of the body can be further assisted if not completely obtained by the contribution generated by the dilated extensible element “E” at the bottom of the pile.

However, in this context, the body is or could be at a lower height than that of the upper storage portion.

In this case it is sufficient to return the extensible element “E” to the compressed configuration keeping the upper wall fixed so as to raise the lower wall until the latter is flush or in any case above the minimum height of the upper storage portion, so as to allow the body to return therein.

For reasons of energy efficiency and to optimise the operation of the system 1, before returning the body to the tank for a further cycle it is possible to rotate it to bring the extensible elements “E” back above the rigid elements.

In accordance with an alternative aspect of the present invention, the energy conversion method is performed by switching at least one extensible element using a pressurised air source, for example a compressor.

In accordance with such an aspect, at least one extensible element is positioned at the lower descent end 3b of the descent channel 3.

Advantageously, the extensible element “E” can be locked in that position by activating the respective locking means 8.

At the same time, the ascent channel 4 is filled with a fluid 100 (for example water) so as to at least partially fill it, completely flooding the connection channel 5 so that an extensible element “E” faces a free surface 110 of the fluid 100 in the connection channel 5.

At this point the extensible element “E” is switched in the dilated configuration by introducing air therein through the pressurised air source.

Specifically, the switching occurs by connecting the extensible element “E” with the pressurised air source and activating the latter to transfer air into the extensible element “E”.

It should be noted that the connection can be made by one or more tubes connectable to the extensible element “E” for example at the same time as the insertion thereof inside the descent channel 3.

The at least one extensible element “E” is then brought from the lower descent end 3b to the lower ascent end 4b conveying it through the connecting channel 5 and it is therefore possible, in a manner similar to what has already been described, to proceed to convert an Archimedean thrust acting inside the ascent channel 4 on the at least one extensible element “E” into kinetic and/or potential energy by moving a body having a predetermined mass, and/or into electrical energy by driving an electric generator.

1. A system for energy conversion, comprising:
a support structure having a descent channel extending vertically between an upper descent end and a lower descent end, an ascent channel extending parallel to the descent channel between an upper ascent end and a lower ascent end and a connection channel extending between the lower descent end and the lower ascent end;
a sealing device applied to the upper descent end and configured to hermetically close said upper descent end;
at least one extensible element switchable between a compressed configuration and a dilated configuration and vice versa and configured to move a fluid volume equal to the predetermined volume difference between the dilated configuration and the compressed configuration, said at least one extensible element being slidable inside the support structure along a working path extending from the upper descent end to the upper ascent end;
a plurality of locking means configured to individually and reversibly constrain respective portions of the at least one extensible element to the support structure.

2. The system according to claim 1, wherein the sealing device defines a transfer chamber and comprises:
an upper panel facing an external environment and having an insertion seat adapted to allow the passage of the extensible elements inside the transfer chamber;
a lower panel facing the descent channel and having an insertion seat adapted to allow the passage of the extensible elements inside the descent channel;
a plurality of peripheral panels configured to fluid-tightly connect the upper panel to the lower panel;
two hatches coupled to respective insertion seats and configured to hermetically close said insertion seats.

3. The system according to claim 1, configured to determine a conversion of potential energy into a useful energy exploitable as a storable kinetic and/or potential energy, preferably said useful energy being kinetic energy exploitable by moving a body having a predetermined mass or being a kinetic/potential energy exploitable to drive an electric generator and to produce electricity.

4. The system according to claim 1, wherein the at least one extensible element in the dilated configuration has a major volume of about 1.1 up to 2.5 times the volume presented in the compressed configuration, even more preferably the at least one extensible element in the dilated configuration has a volume equal to at least double the volume presented in the compressed configuration.

5. The system according to claim 1, wherein the at least one extensible element has a convex shaped upper wall and a concave lower wall mutually coupled by means of a deformable and/or extensible connecting peripheral wall.

6. The system according to claim 1, wherein the connecting peripheral wall comprises an impermeable elastic-type sheath or a composition of a plurality of impermeable rigid elements which are collapsible on each other in a compressed extensible element configuration and which are unwindable in a dilated extensible element configuration.

7. The system according to claim 1, comprising a plurality of extensible elements organisable in a pile of extensible elements stacked and interconnected with each other.

8. The system according to claim 7, wherein the extensible elements comprise interconnection means configured to mechanically and fluid-tightly connect each extensible element to at least one adjacent extensible element and having a communication duct configured to put each extensible element in fluid communication and at least one adjacent extensible element in a condition of extensible elements arranged in a pile.

9. The system according to claim 8, wherein the communication ducts of the extensible elements are mutually connectable so as to realise a single communication duct extending from an upper extensible element of the pile to a lower extensible element of the pile.

10. The system according to claim 1, wherein the locking means are configured to reversibly constrain the upper wall and/or the lower wall of the at least one extensible element to an inner wall of the descent channel.

11. The system according to claim 1, comprising a tank arranged below the ascent channel and placed in fluid communication with the lower ascent end, said tank being configured to contain in a use configuration an amount of fluid sufficient to at least completely fill the ascent channel and the connection channel.

12. A method for energy conversion, comprising the steps of:
arranging a system for energy conversion according to claim 1 comprising a plurality of extensible elements;
arranging, at the upper descent end, a pile of extensible elements in which an upper extensible element is in a dilated configuration and contains an air mass and each other extensible element is in a compressed configuration;
locking, by means of the respective locking means, a movement of the extensible elements inside the descent channel;
hermetically closing the upper descent end by means of the sealing device;
filling the ascent channel with fluid so as to at least partially fill it, completely flooding the connection channel so that a lower extensible element faces a free surface of the fluid in the connection channel;
unlocking the lower extensible element by detaching said lower extensible element from an immediately overlying extensible element until said lower extensible element is completely immersed in the fluid;
unlocking a lower wall of the immediately overlying extensible element;
transferring the air mass from the upper extensible element to the immediately overlying extensible element, restoring the compressed configuration of the upper extensible element and causing the dilation of the immediately overlying extensible element until it is reconnected with the lower extensible element;
locking the upper wall of the lower extensible element by unlocking each other extensible element, so as to promote the movement of the air mass to the lower extensible element under the thrust of the weight force of the pile of extensible elements;
moving the lower extensible element from the lower descent end to the lower ascent end by conveying it through the connection channel;
converting an Archimedean thrust acting inside the ascent channel on said lower extensible element into kinetic and/or potential energy by moving a body having a predetermined mass, and/or into electricity by driving an electric generator.

13. The method according to claim 12, wherein the step of arranging the system is performed by arranging a system for energy conversion, said method further comprising the steps of:
providing an extensible element in the dilated configuration;
inserting the extensible element in the transfer chamber through the insertion seat of the upper panel while the hatch coupled to the insertion seat of the lower panel is closed;
closing the hatch coupled to the insertion seat of the upper panel;
opening the hatch coupled to the insertion seat of the lower panel and transferring the extensible element into the descent channel connecting it to the pile of extensible elements so as to define an upper extensible element of said pile.

14. The method according to claim 12, wherein said step of arranging a system is performed by arranging a system according to claim 10, wherein the tank contains an amount of fluid sufficient to completely fill the ascent channel and the connection channel and said filling step is performed by immersing a body inside the tank causing the fluid to move inside the connection channel and the ascent channel.

15. The method for energy conversion, comprising the steps of:
arranging a system for energy conversion according to claim 1;
arranging at the lower descent end the at least one extensible element in a compressed configuration;
hermetically closing the upper descent end by means of the sealing device;
filling the ascent channel with fluid so as to at least partially fill it, completely flooding the connection channel so that the at least one extensible element faces a free surface of the fluid in the connection channel;
switching said at least one extensible element in the dilated configuration;
moving the at least one extensible element from the lower descent end to the lower ascent end, conveying it through the connection channel;
converting an Archimedean thrust acting inside the ascent channel on said at least one extensible element into kinetic and/or potential energy by moving a body having a predetermined mass, and/or into electricity by driving an electric generator.

16. The method according to claim 15, wherein said switching step is performed by connecting the at least one extensible element to a pressurised air source and conveying an air flow inside the at least one extensible element.
